(19) United States
(12) Patent Application Publication
(10) Pub. No.: US 2012/0231412 A1
(43) Pub. Date: Sep. 13, 2012

(54) ORAL APPLIANCE FOR MEDICAL TREATMENT

(75) Inventors: Davud Baradaran Sirjani, Fremont, CA (US); Andrew Thomas Hosford, Mountain View, CA (US); Dale Jon Waters, Palo Alto, CA (US); Elizabeth Zambricki, Palo Alto, CA (US); Laura Sarah Sasportas, San Francisco, CA (US); Maria Anne Sodini, Palo Alto, CA (US); Joelle Karine Barral, Palo Alto, CA (US)

(73) Assignee: The Board of Trustees of the Leland Stanford Junior University, Palo Alto, CA (US)

(21) Appl. No.: 13/413,401

(22) Filed: Mar. 6, 2012

Related U.S. Application Data
(60) Provisional application No. 61/450,132, filed on Mar. 8, 2011.
(60) Provisional application No. 61/484,196, filed on May 9, 2011.

(51) Int. Cl. A61C 19/06

(52) U.S. Cl. 433/89

(57) ABSTRACT

An oral treatment apparatus is provided. A dental mount for mounting on teeth within a mouth is provided. A compartment is connected to and supported by the dental mount. A fluid absorbent substrate is within the compartment. The compartment may be formed by a permeable membrane. The compartment may be detachably connected to the dental mount.

### CROSS REFERENCE TO RELATED APPLICATIONS

This application claims priority under 35 U.S.C. §119(e) from co-pending U.S. Provisional Application No. 61/450,132, entitled “METHOD AND/OR DEVICE TO PREVENT AND/OR TREAT XEROSTOMIA”, filed Mar. 8, 2011, by Andrew Hosford and U.S. Provisional Application No. 61/484,196, entitled “METHOD AND/OR DEVICE TO PREVENT AND/OR TREAT XEROSTOMIA”, filed May 9, 2011, by Andrew Hosford, which are both incorporated by reference in their entirety for all purposes.

### BACKGROUND OF THE INVENTION

This invention relates generally to oral medical treatments.

Xerostomia, or subjective dryness of the mouth, is a condition that can be the result of a number of physiological and pathological factors. Persons suffering from dry mouth can experience difficulty swallowing, speaking, eating, and sleeping. More serious cases of xerostomia can result in dental caries, as well as oral blisters and infections of the oral mucosal linings. It is a detriment to the quality of life of its sufferers.

### SUMMARY OF THE INVENTION

In accordance with the invention, an oral treatment apparatus is provided. A dental mount for mounting on teeth within a mouth is provided. A compartment is connected to and supported by the dental mount. A fluid absorbent substrate is within the compartment.

The invention and objects and features thereof will be more readily apparent from the following detailed description and appended claims when taken with the drawings.

### BRIEF DESCRIPTION OF THE DRAWINGS

FIG. 1 is a cut away perspective view of an embodiment of the invention.

FIG. 2 is a perspective view of a detachable dental mount in another embodiment of the invention.

FIG. 3 is a perspective view of a detachable compartment in an embodiment of the invention.

FIG. 4 is a perspective view of a detachable dental mount in another embodiment of the invention.

FIG. 5 is a perspective view of a detachable compartment in an embodiment of the invention.

FIG. 6 is a perspective view of a slow release drug microbead.

### DETAILED DESCRIPTION OF ILLUSTRATED EMBODIMENTS

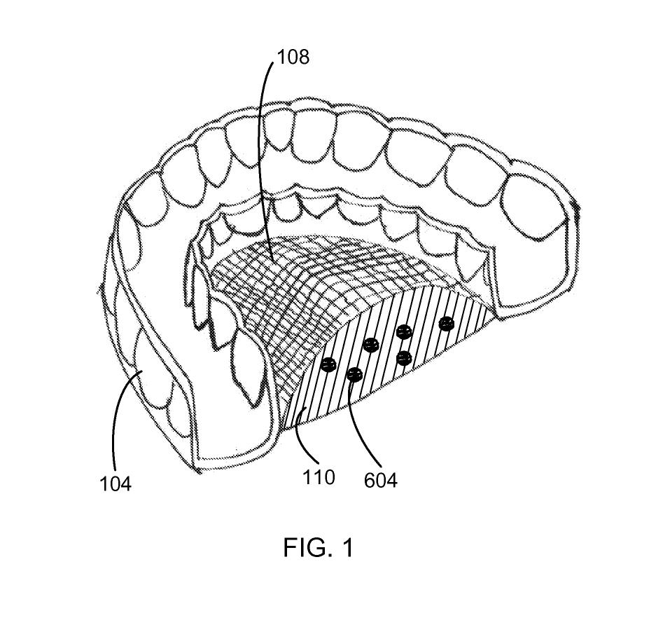

To facilitate the understanding of the invention, FIG. 1 is a schematic and partially cut away view of an embodiment of the invention. An oral appliance comprises a dental mount 104. In this embodiment, the dental mount 104 is a U-shaped channel, formed to be mounted on and supported by an upper set of teeth. Such a U-shaped channel may be a mouth guard or dental night guard formed from acrylic or thermoset resin. U.S. Pat. No. 5,103,838, entitled “Dental Night Guard,” which is incorporated by reference for all purposes, describes a process of making a dental night guard, which first takes an alginate impression of a patient's upper or lower set of teeth, then forms a model of the teeth using plaster, and then forms the dental night guard from the model.

A permeable membrane 108, which is shown as a mesh, forms a compartment, which is connected to the dental mount 104. Within the compartment is a fluid absorbent substrate 110, which is a gel like substance shown by shading with embedded microbeads 604. Part of the permeable membrane 108 is shown cut away to show the fluid absorbent substrate 110. In this embodiment, the permeable membrane 108 is a material that does not dissolve in water and has pores large enough to allow water and other molecules to pass through but small enough to prevent the absorbent substrate 110 from passing through, such as being between sub-micron to several hundred microns in diameter. In this embodiment, the permeable membrane 108 is a sheet or mesh of flexible and/or elastic polymers or metals. For example, the permeable membrane may be formed from nylon or silicone. In this embodiment, the fluid absorbent substrate 110 is a hydrophilic polymer. In operation, a fluid absorbent substrate is filled with a fluid. The dental mount is mounted on teeth within a mouth. Either applied pressure, partial pressure caused by evaporation, diffusion, degradation of the substrate, or some other mechanism allows the fluid in the fluid absorbent substrate to be provided to the mouth over a period of time. The diffusion of the liquid may be active or passive. An example of passive diffusion, would be how the liquid diffuses out of the compartment without any motion outside the compartment. An example of active diffusion, which would be faster than passive diffusion, would be diffusion from movement outside of the compartment, such as movement of the tongue against the compartment to provide pressure or such as the flow of fluid through the compartment. After the fluid is dispensed, the apparatus may be removed from the mouth.

In this embodiment, the fluid is a hydration fluid that keeps regions of the mouth moist. In another embodiment, the fluid contains a medicinal component, such as an antibiotic. In other embodiments, the fluid may contain drugs or buffering agents (salts) and proteins such as mucin 1, mucin 2, lactoferrin, peroxidases, amaylases, carbonic anhydrases, proline-rich proteins, lysozyme, slatherins, and/or histatins to mimic the functions of natural saliva.

The hydrophilic polymer to be used in this device may consist of poly(ethylene glycol), polyacrylamide, poly(N-isopropylacrylamide), poly(hydroxyacrylate), poly(vinyl alcohol), polyoxazoline, poly(vinyl pyrrolidone), poly(hydroxy methacrylate), poly(acrylic acid)/salts thereof, poly(methacrylic acid)/salts thereof, carbohydrate based polymers such as hydroxyethyl cellulose, hyaluronan, chitosan or dextran.

In this embodiment of the invention, the permeable membrane 108 forms a compartment with a volume preferably between 1 cc and 50 cc. Preferably, the fluid is dispensed over a time greater than 60 minutes. More preferably, the fluid is dispensed over a time greater than 600 minutes. Most preferably, the fluid is dispensed over a time between 10 and 12 hours. The slow release of the fluid by the hydrophilic substrate allows the substrate to provide stable or homeostatic moisture.

The dental mount may have other configurations, such as mounting to the lower set of teeth instead of the upper set of teeth. In another embodiment, instead of providing a U-shaped channel, the dental mount is mounted on a smaller portion of a tooth set.

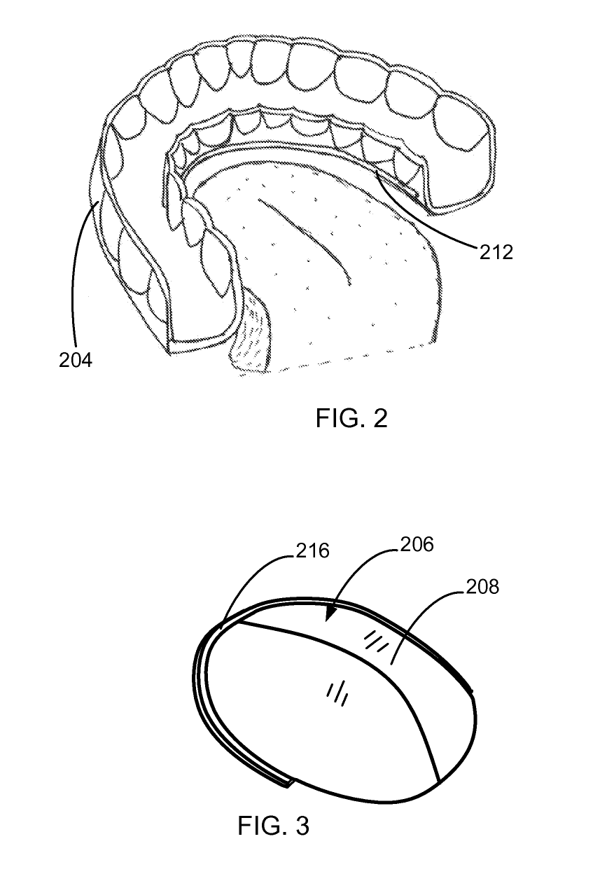

FIG. 2 and FIG. 3 show another embodiment of the invention with a dental mount 204 that is detachable from a compartment 206 formed by a permeable membrane 208. The absorbent substrate is within the compartment formed by the permeable membrane. The dental mount 204 has a groove 212. The compartment 206 has a tongue 216, which fits into the groove 212, which allows the compartment 206 to be detachably attached to the dental mount 204. In other embodiments, compartment may be detachably attached by a fastener, zipper, or by having part of the compartment held between the dental mount 204 and the teeth. In this embodiment, the compartment may be removed from the dental mount and replaced with another compartment. The dental mount is easy to clean and may be expensive if made to have a custom fit with an individual's teeth. The compartment and fluid absorbent substrate may be difficult to keep clean, but could be made inexpensively, since a custom fit is not required. Therefore, an advantage provided by a detachable compartment is that an old compartment and substrate may be replaced with a new and sterile compartment and substrate, while eliminating the expense of providing a new dental mount with each change of a compartment and substrate.

In an embodiment where the dental mount is inexpensively produced, the compartment does not need to be detachable, but instead the entire device may be replaced with a new one.

Embodiments of the invention may be used for treatment of xerostomia, by providing moisture over a period of time.

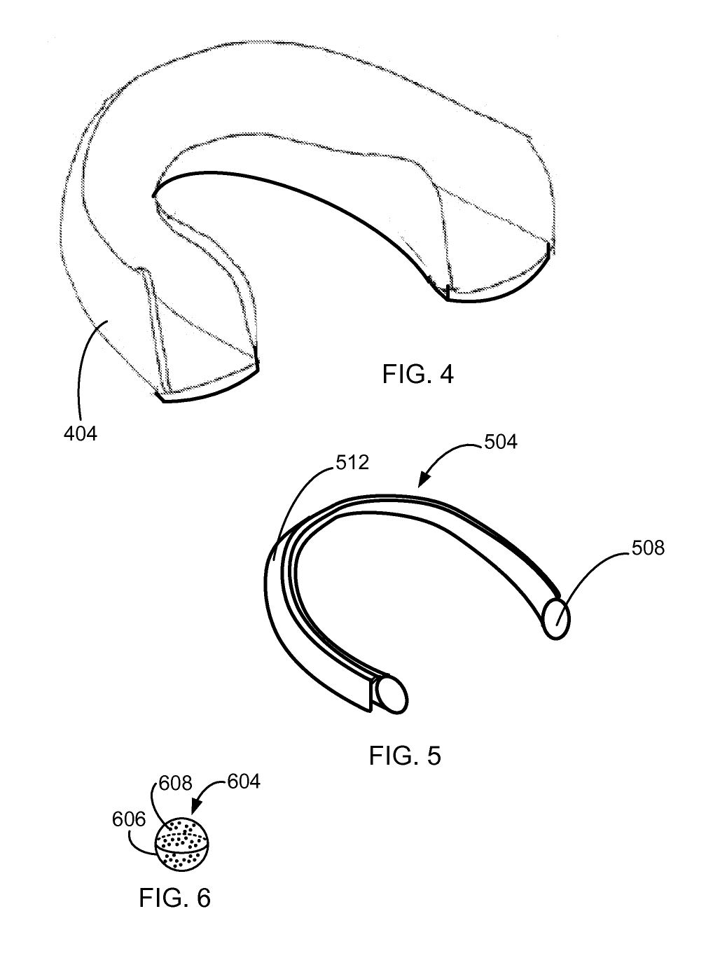

FIG. 4 is a view of the dental mount 404 in another embodiment of the invention. In this embodiment, a groove is not needed. FIG. 5 is a perspective view of a compartment 508 and a connector, which is a soft flange 512 that allows the compartment 508 to be detachably connected to the dental mount. In this embodiment, the soft flange 512 is placed within the trough of the dental mount 404 so that when the dental mouth is placed on the teeth the soft flange 512 is between the teeth and a sidewall of the trough of the dental mount so that the force between the teeth and the dental mount holds the flange 512 in place, which holds the compartment 508 in place.

FIG. 6 is an enlarged view of the slow release microbead 604. In this embodiment the slow release microbead may contain a drug within a shell 606 with a plurality of small apertures 608. The small apertures provide a slow release of the drug within the shell. In an embodiment of the invention, a plurality of microbeads is placed in the compartment with the fluid absorbent substrate. Such an embodiment provides a slow release of a drug such as an antibiotic, antifungal, steroid, or other medicine, which may be desired to be released in the oral cavity, while also providing moisture. Preferably, the microbeads are larger than the apertures in the permeable membrane. More preferably, the microbeads are between 10 microns to 1 mm in diameter. Other embodiments may provide other slow release drug components in the compartment with the fluid absorbent substrate. The shell may be made of at least one of polyethylene, polystyrene, or a starch. With a starch component, saliva/fluids would be soaked up by the starch and enzyme amylase in the saliva would digest the starch releasing the medication. Such microbeads with starch would have pores large enough to allow amylase into the bead to digest the starch, which contains the medication.

While this invention has been described in terms of several preferred embodiments, there are alterations, permutations, modifications and various substitute equivalents, which fall within the scope of this invention. It should also be noted that there are many alternative ways of implementing the methods and apparatuses of the present invention. It is therefore intended that the following appended claims be interpreted as including all such alterations, permutations, modifications, and various substitute equivalents as fall within the true spirit and scope of the present invention.

What is claimed is:

1. An apparatus, comprising
a dental mount for mounting on teeth within a mouth;
a compartment connected to and supported by the dental mount; and
a fluid absorbent substrate within the compartment.

2. The apparatus, as recited in claim 1, wherein the compartment comprises a permeable membrane.

3. The apparatus, as recited in claim 2, wherein the compartment comprises a connector that detachably connects the compartment to the dental mount, so that the compartment may be removed from the dental mount and another compartment may be attached.

4. The apparatus, as recited in claim 3, further comprising a fluid within the fluid absorbent substrate.

5. The apparatus, as recited in claim 4, wherein the substrate is a homeostatic substrate that provides a slow release of the fluid.

6. The apparatus, as recited in claim 5, wherein the substrate is a hydrophilic polymer.

7. The apparatus, as recited in claim 6, wherein the fluid is an aqueous solution.

8. The apparatus, as recited in claim 7, wherein the fluid is a hydration fluid or a medicine.

9. The apparatus, as recited in claim 7, wherein the fluid comprises an antibiotic, drugs, buffering agents (salts), or proteins.

10. The apparatus, as recited in claim 9, wherein the dental mount is in a U-shape with a first leg and second leg, wherein the compartment is supported between the first leg and the second leg.

11. The apparatus, as recited in claim 10, wherein the hydrophilic polymer comprises poly(ethylene glycol), polyacrylamide, poly(N-isopropylacrylamide), poly(hydroxyacrylate), poly(vinyl alcohol), polyoxazoline, poly(vinyl pyrrolidone), poly(hydroxy methacrylate), poly(acrylic acid)/salts, poly(methacrylic acid)/salts, or carbohydrate based polymers.

12. The apparatus, as recited in claim 11, wherein the connector comprises one of a tongue, groove, zipper, or fastener system.

13. The apparatus, as recited in claim 12, further comprising a slow release drug component within the compartment.

14. The apparatus, as recited in claim 13, wherein the slow release drug component comprises a plurality of microbeads.

15. The apparatus, as recited in claim 1, further comprising a fluid within the fluid absorbent substrate.

16. The apparatus, as recited in claim 15, wherein the substrate is a homeostatic substrate that provides a slow release of the fluid.

17. The apparatus, as recited in claim 1, wherein the substrate is a hydrophilic polymer.

18. The apparatus, as recited in claim 1, further comprising a slow release drug component within the compartment.
